(19) United States
(12) Patent Application Publication
(10) Pub. No.: US 2017/0123522 A1
(43) Pub. Date: May 4, 2017

(54) CAPACITIVE STYLUS

(71) Applicant: WALTOP INTERNATIONAL CORPORATION, Hsinchu City (TW)

(72) Inventors: CHUNG-FUU MAO, Hsinchu City (TW); HSIN-CHIANG HO, Hsinchu City (TW)

(21) Appl. No.: 14/964,919

(22) Filed: Dec. 10, 2015

(30) Foreign Application Priority Data
Oct. 30, 2015 (TW) 104135709

(51) Int. Cl. G06F 3/0354

(52) U.S. Cl. CPC G06F 3/03545

(57) ABSTRACT

A capacitive stylus is disclosed. The capacitive stylus comprises a conductive nib, a confining component, a spring, a conductive line and a control circuit board. The conductive nib electrically connects to the control circuit board via the spring and the conductive line. The confining component prevents the spring and the conductive line from lateral movement.

### CROSS-REFERENCE TO RELATED APPLICATIONS

The entire contents of Taiwan Patent Application No. 104135709, filed on Oct. 30, 2015, from which this application claims priority, are expressly incorporated herein by reference.

1. Field of the Invention

The present invention relates to a capacitive stylus, and more particularly to a capacitive stylus which is easy to manufacture and assemble.

2. Description of the Prior Art

Capacitive touch input technology which is widely used in the touch panel not only allows user to proceed input operation via user's hand, but also provide a more exquisite writing input operation by using a handheld capacitive stylus to present various functions including stroke thickness changes. A capacitive stylus includes a conductive nib or tip so as to emit signals to a touch panel. In order to emit signals of the capacitive stylus, the conductive nib or tip must connect to a control circuit through a plurality of conductive components inside the capacitive stylus. However, the conductive components may cause problems of quality or production line or increases of production time and cost due to errors of soldering or component dimension or poor assemble quality.

Thus the invention provide a capacitive stylus which is easy to manufacture and assemble so as to prevent problems of quality or production line or increases of production time and cost due to dimension errors or poor assemble quality.

### SUMMARY OF THE INVENTION

An object of the present invention is to provide a capacitive stylus which is easy to manufacture and assemble.

According to the object, one embodiment of the present invention provides a capacitive stylus capacitive stylus comprising a conductive nib, a nib holder, a spring surrounding and electrically connecting the nib holder, a sensor holder, a pressure sensor, a sensor board having the pressure sensor thereon, a control circuit board electrically connecting the sensor board, a conductive line electrically connecting the spring and a confining component. The conductive nib penetrates and combines with the nib holder. The conductive line electrically connects the spring so as to electrically connect the conductive nib to the control circuit board via the nib holder and the spring. The confining component allows the spring or the conductive line to extend through to prevent the spring or the conductive line from lateral movement.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a schematic view of a capacitive stylus 100 according to one embodiment of the invention.

FIG. 2 is a schematic interior view of a capacitive stylus according to one embodiment of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

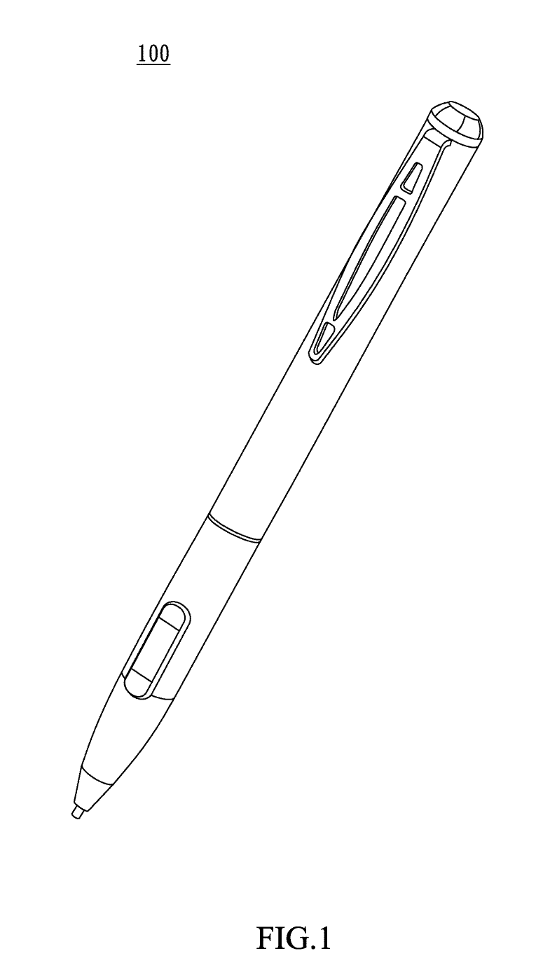

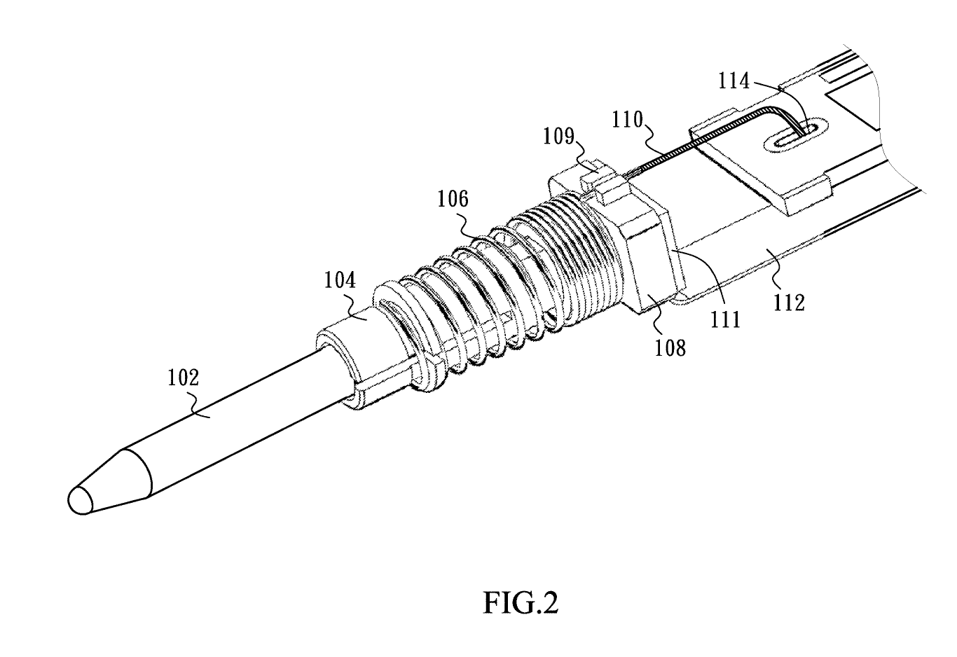

FIG. 1 is a schematic view of a capacitive stylus 100 according to one embodiment of the invention. FIG. 2 is a schematic interior view of a capacitive stylus according to one embodiment of the invention. As shown in FIG. 2, a capacitive stylus comprises a nib 102, a nib holder 104, a spring 106, a sensor holder 108, a confining component 109, a conductive line 110, a sensor board 111, a flexible printed circuit board 112 and a control circuit board 114.

The nib 102 comprises a replaceable conductive nib. The material of the nib 102 comprises metals or any suitable conductive materials. The nib holder 104 is configured to accommodate one end of the nib 102 to secure and contact with the nib 102. The material of the nib holder 104 comprises any suitable conductive materials, but preferably metals. The spring 106 surrounds and contacts with the nib holder 104 so as to connect the nib 102 and the nib holder 104 to the control circuit board 114 through the conductive line 110. The material of the spring 106 preferably comprises metals. In this embodiment, the spring 106 extends through the confining component 109 and connects with the conductive line 110, and the conductive line 110 connects with the control circuit board 114. In this embodiment, the confining component 109 comprises two bulge portions to prevent the spring 106 or the conductive line 110 from lateral movement. The confining component 109 can be a part of the sensor holder 108 or an element configured to being mounted on the sensor holder 108 or a component located inside the capacitive stylus 100. In other embodiment, the confining component 109 comprises any suitable component which allows the spring 106 or the conductive line 110 to extend through and prevents the spring 106 or the conductive line 110 from lateral movement. The spring 106 can be connected to the conductive line 110 via any suitable techniques, such as soldering, but not limited to soldering. The conductive line 110 can be connected to the control circuit board 114 via any suitable techniques, such as soldering, but not limited to soldering.

High voltage signals of the capacitive stylus are emitted from the circuit on the control circuit board 114 through the conductive line 110, the spring 106, the nib holder 104 and the nib 102. The spring 106 is configured to restore the nib 102 back to original position after the tip pressure applied on the nib 102 vanishes. When a tip pressure is applied upon the nib 102, the nib 102 and the nib holder 104 compress the spring 106. The restoring force of the spring 106 pushes the nib 102 and the nib holder 104 back to original position after the tip pressure is removed. The sensor holder 108 is configured to secure a pressure sensor (not shown) on the sensor board 111. The sensor board 111 connects to the control circuit board 114 through the flexible printed circuit board 112. When a tip pressure is applied upon the nib 102, the nib holder 104 which combines with the nib 102 transmits the tip pressure to the pressure sensor. The pressure sensor sends signals to the control circuit board 114 via the flexible printed circuit board 112 so as to calculate tip pressure values of the capacitive stylus.

The invention utilizes a conductive line to connect a spring to a control circuit board in a capacitive stylus so that the spring only needs to fit the dimension of a nib holder. The precision requirement of dimension of the spring can be lessened since the spring does not need to be soldered to the control circuit board, extend across the pressure sensor and meet the axial dimension requirement. Thus the spring is easy to manufacture and the capacitive stylus is easy to produce and assemble on the production line. Therefore, the production time and cost can be saved.

It is noted that the configuration, shape and material of the components of the embodiment mentioned above and shown are examples instead of limitations, any equivalents, alternatives or modifications of the embodiment corresponding to the spirit of invention should be encompassed in the scope of the invention. More details about connecting configurations, functions and operations of the components of the capacitive stylus according to embodiments of the invention which are known, appreciated and enabled by those with ordinary skill in the art are omitted herein.

Although specific embodiments have been illustrated and described, it will be appreciated by those skilled in the art that various modifications may be made without departing from the scope of the present invention, which is intended to be limited solely by the appended claims.

What is claimed is:

1. A capacitive stylus, comprising:
a conductive nib and a nib holder, the conductive nib penetrating and combining with the nib holder;
a spring surrounding and electrically connecting the nib holder;
a sensor holder, a pressure sensor and a sensor board having the pressure sensor thereon;
a control circuit board electrically connecting the sensor board;
a conductive line electrically connecting the spring so as to electrically connect the conductive nib to the control circuit board via the nib holder and the spring; and
a confining component, wherein the confining component allows the spring or the conductive line to extend through to prevent the spring or the conductive line from lateral movement.

2. The capacitive stylus according to claim 1 further comprising a flexible printed circuit board connecting the sensor board to the control circuit board.

3. The capacitive stylus according to claim 1, wherein the confining component is configured to be located on the sensor holder.

4. The capacitive stylus according to claim 1, wherein the conductive line is connected to the spring by soldering.

5. The capacitive stylus according to claim 1, wherein the conductive line is connected to the control circuit board by soldering.

6. A capacitive stylus, comprising:
a conductive nib and a nib holder, the conductive nib penetrating and combining with the nib holder;
a spring surrounding and electrically connecting the nib holder;
a sensor holder having a confining component, a pressure sensor and a sensor board having the pressure sensor thereon;
a control circuit board electrically connecting the sensor board; and
a conductive line electrically connecting the spring so as to electrically connect the conductive nib to the control circuit board via the nib holder and the spring, wherein the confining component allows the spring or the conductive line to extend through to prevent the spring or the conductive line from lateral movement.

7. The capacitive stylus according to claim 6, wherein the confining component comprises two bulge portions to prevent the spring or the conductive line from lateral movement.

8. The capacitive stylus according to claim 6, wherein the conductive nib comprises a replaceable conductive nib.
